(19) United States
(12) Patent Application Publication
(10) Pub. No.: US 2018/0101513 A1
(43) Pub. Date: Apr. 12, 2018

(54) INFORMATION BACKUP SYSTEM AND METHOD OF STORING PERSONAL INFORMATION TO BE RETRIEVED IN INSTANCES OF EMERGENCY

(71) Applicant: Tina Francais Olexa, Langley (CA)

(72) Inventor: Tina Francais Olexa, Langley (CA)

(21) Appl. No.: 15/730,609

(22) Filed: Oct. 11, 2017

Related U.S. Application Data
(60) Provisional application No. 62/406,681, filed on Oct. 11, 2016.

(51) Int. Cl. G06F 17/24; G06F 3/0482; G06F 3/0488

(52) U.S. Cl. CPC G06F 17/243; G06F 17/30126; G06F 3/0488; G06F 3/0482

(57) ABSTRACT

An information backup system is used as a mobile application capable of storing personal information for retrieval during emergency situations. A primary user stores their personal information, and authorizes a second user for information retrieval in instances where the primary user is incapacitated. Information stored includes, but is not limited to birth dates, social security numbers, asset account information, login and password information for computers and websites, etc.

### CROSS REFERENCE TO RELATED APPLICATION

The present application is related to and claims priority to U.S. Provisional Patent Application No. 62/406,681 filed Oct. 11, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of data management and more specifically relates to personal information backup and retrieval.

### 2. Description of Related Art

A mobile application is a computer program designed to run on smartphones, tablet computers and other mobile devices. Mobile applications were originally offered for general productivity and information retrieval, including email, calendar, contacts, and stock market and weather information. However, public demand and the availability of developer tools drove rapid expansion into other categories, such as mobile games, factory automation, GPS and location-based services, banking, order-tracking, ticket purchases and recently mobile medical applications. The explosion in number and variety of applications made discovery a challenge, which in turn led to the creation of a wide range of review, recommendation, and curation sources, including blogs, magazines, and dedicated online application-discovery services. Many new applications are desirable to provide convenient solutions to the users.

U.S. Pub. No. 2014/0258828 to Brent Lymer relates to a pick-and-place webform autofill. The described pick-and-place webform autofill includes an autofill browser extension or smartphone app provides for the secure storage and autofill populating of webforms with personal user information. A popup menu of stored answers appears in front of or next to a form requesting a user to fill it out. The user selects the right answer to each question and simply drags and drops it, or picks and places it in the corresponding spot in the webform. If the answer needs to be a new one, the user clicks on the box for it in the webform, enters the answer. In alternative embodiments that answer can be automatically added to the menu. Autofill database maintenance is easy and intuitive. A template describing the construction and URL location of the webform is automatically registered with a server and that enables a community of users to share in quicker, easier, form fills.

### BRIEF SUMMARY OF THE INVENTION

In view of the foregoing disadvantages inherent in the known data management art, the present disclosure provides a novel information backup system. The general purpose of the present disclosure, which will be described subsequently in greater detail, is to provide an efficient and effective information backup system and method of storing personal information to be retrieved in instances of emergency.

An information backup system and method of storing personal information to be retrieved in instances of emergency is disclosed herein. The information backup system and method of storing personal information to be retrieved in instances of emergency includes a software application supported on a platform server including a database, the software application configured for storage and access of personal information, a computing device for installation of the software applications, a user interface for accessing and manipulating the software application and the personal information. The software application stores the personal information for remote access to the personal information in emergency situations.

Many forms of personal information may be stored including pictures, family relations, contacts, medical, employer, benefits, insurance, birth certificates, social security numbers, passports, marriage certificates, divorce certificates, debt accounts, bank accounts, website login and password information, safes, safety deposit boxes, locations of keys, asset information, wills, power of attorney, medical directives, living wills, long term care, arrangements, and organ donation, etc. Additional personal information may be added to the information backup system as needed and relevant.

A method of using the described information backup system and method of storing personal information to be retrieved in instances of emergency is also disclosed herein. The method of using information backup system and method of storing personal information to be retrieved in instances of emergency may comprise the steps of: providing a software application supported on a platform server including a database, the software application configured for storage and access of personal information, providing a computing device for installation of the software applications, providing a user interface, accessing and manipulating the software application and the personal information, inputting the personal information, and storing the personal information for remote access to the personal information.

The method of storing personal information to be retrieved in instances of emergency further comprises the steps of: creating additional categories for inputting the personal information, authorizing access for a guest-user, uploading the personal information, and logging in to the software application.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an information backup system, constructed and operative according to the teachings of the present disclosure.

FIG. 1 is a screen shot view of an information backup system during an ‘in-use’ condition showing the many forms of personal information which can be recorded according to an embodiment of the present invention.

FIG. 2 is a screen shot view of the information backup system during an ‘in-use’ condition showing emergency contact information for several agencies according to an embodiment of the present invention.

FIG. 3 is a screen shot view of the information backup system during an ‘in-use’ condition showing the many forms of personal information which can be recorded according to an embodiment of the present invention.

FIG. 4 is a screen shot view of the information backup system during an ‘in-use’ condition showing the many forms of personal information which can be recorded according to an embodiment of the present invention.

FIG. 5 is a screen shot view of the information backup system during an ‘in-use’ condition showing the many forms of personal information which can be recorded according to an embodiment of the present invention.

FIG. 6 is a screen shot view of the information backup system during an ‘in-use’ condition showing the many forms of personal information which can be recorded according to an embodiment of the present invention.

FIG. 7 is a flow diagram illustrating a method of storing personal information to be retrieved in instances of emergency, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to data management and more particularly to an information backup system as used to improve personal information backup and retrieval.

The information backup system organizes all personal data into a single program that stores information such as personal identification information, medical history, assets, beneficiary information and the like. All aspects of personal information may be managed through the information backup system and arranged within the application so that in instances of any emergency, personal information is readily accessible to the primary user or a secondary user, in cases where the primary user is incapacitated. Data is entered into the information backup system, and secured by the primary user for access at any time. Information may be added as needed.

The personal information stored within the information backup system may be used in every area of personal information including other internet, and alternately, computer based programs to maintain a list of login information relevant to each area such as computer login information, any social media website login information, and the like. Data is entered into the information backup system, and secured. Digital assets may also be cataloged so that they may be handled accordingly.

Many forms of personal information may be recorded such as pictures, family relations, contacts, medical, employer, benefits, insurance, birth certificates, social security numbers, passports, marriage certificates, divorce certificates, debt accounts, bank accounts, website login and password information, safes, safety deposit boxes, locations of keys, asset information, wills, power of attorney, medical directives, living wills, long term care, arrangements, organ donation, etc. Any other information a person feels important may also be added to the information backup system. Profile information may contain birth records, identification cards, and social security number for the primary user. All information may be input into the system by entering the information with the user interface. Documents may be saved as an image and may be printed out at a later date in the event the original document is destroyed.

Emergency and non-emergency contact numbers may be added and updated as needed when changes in the information arises. Household items may be added along with the receipt to prove worth of the item should the item become lost, stolen or damaged. User names and passwords for personal computers, mobile devices, and online accounts may also be added and updated as needed when changes occur. Any digital assets may be included and adjusted as needed. Assigning a guest user is optional, but is recommended for instances where the primary user may be incapacitated.

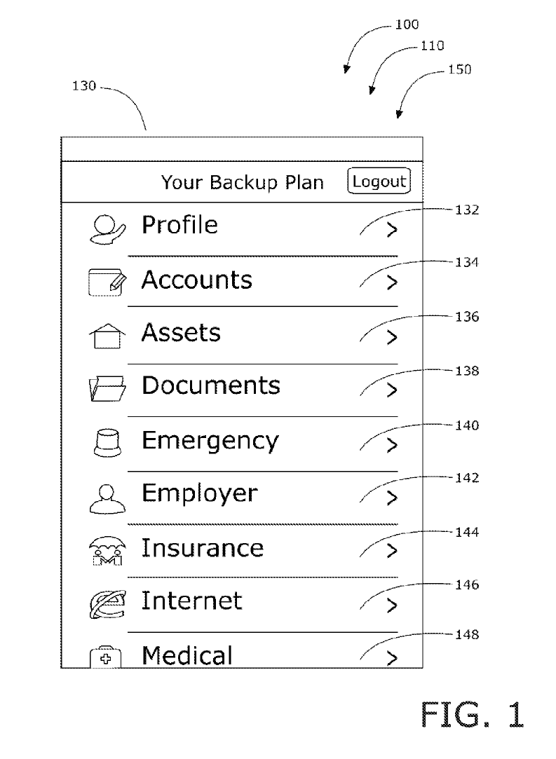

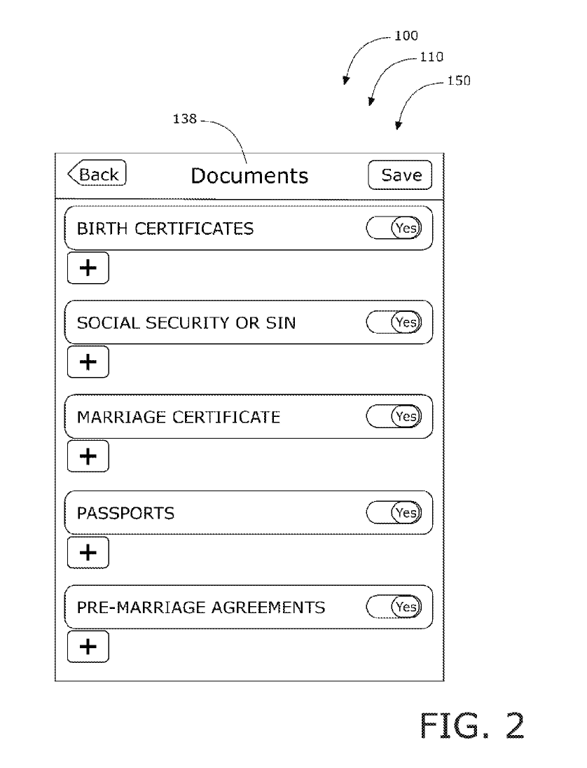

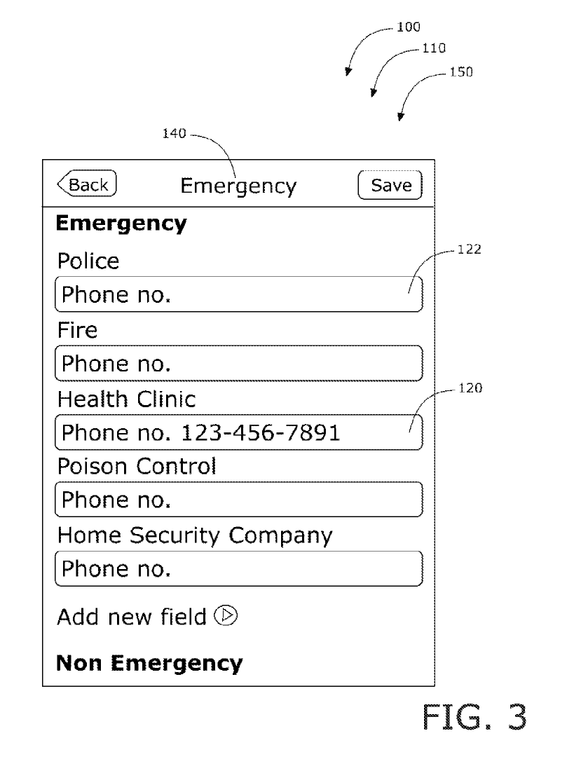

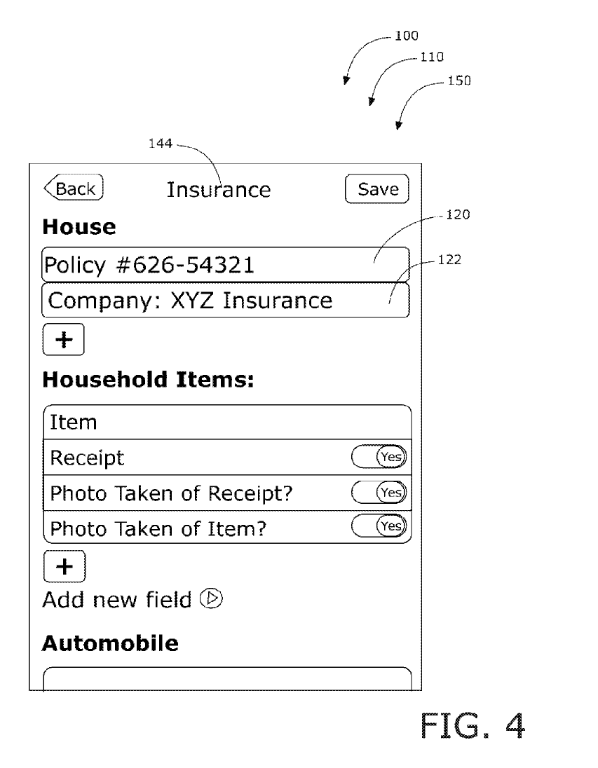

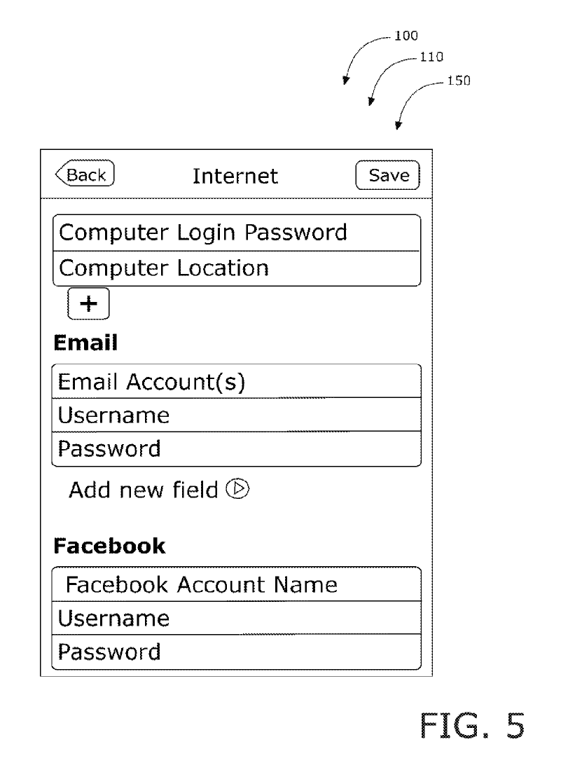

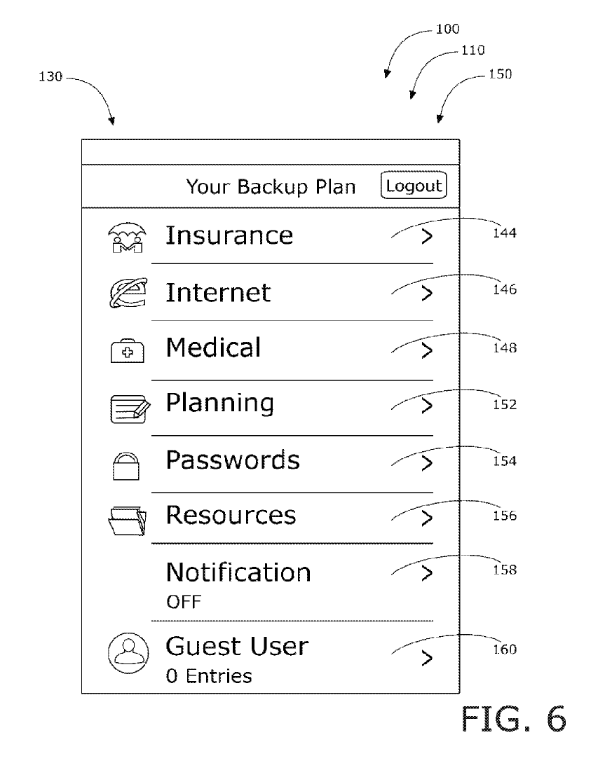

Referring now more specifically to the drawings by numerals of reference, there is shown in FIGS. 1-7, various views of an information backup system and method of storing personal information to be retrieved in instances of emergency 100. FIGS. 1-6 show various views of an information backup system and method of storing personal information to be retrieved in instances of emergency 100 during an ‘in-use’ condition 150, according to an embodiment of the present disclosure. As illustrated, the information backup system 100 may include a software application 110 supported on a platform server including a database, the software application 110 configured for storage and access of personal information, a computing device for installation of the software applications 110, a user interface for accessing and manipulating the software application 110 and the personal information. The software application 110 stores the personal information 120 for remote access to the personal information 120 in emergency situations.

The personal information 120 may include but is not limited to pictures, family relations, contacts, medical, employer, benefits, insurance, birth certificates, social security numbers, passports, marriage certificates, divorce certificates, debt accounts, bank accounts, website login and password information, safes, safety deposit boxes, locations of keys, asset information, wills, power of attorney, medical directives, living wills, long term care, arrangements, and organ donation. The personal information 120 may be accessed by a user or guest-user remotely. The software application 110 is displayed on a screen of the computing device. The computing device may comprise a computer or mobile-device such as a tablet or cellphone. Other electronic devices may be used.

The software application 110 includes form fields 122 to be populated and stored with the personal information 120. The personal information 120 is configured to be stored and presented through a series of selectable menus 130 which are configured to be selected on a computing device. The software application 110 further comprises a user-profile 132 for storing a plurality of items. User-profile 132 may contain birth records, identification cards, and social security number for the user. The user comprises a guest-user in the instances of emergency. The user authorizes the guest-user for information retrieval in instances where the user is incapacitated. The software application 110 comprises a secure access component configured to prevent unauthorized access to the personal information 120.

The series of selectable menus 130 provides access to the user-profile 132, the personal information 120 regarding accounts, the personal information 120 regarding assets, the personal information 120 regarding documents, the personal information 120 regarding emergency, the personal information 120 regarding employer, the personal information 120 regarding insurance, the personal information 120 regarding internet, the personal information 120 regarding medical, the personal information 120 regarding planning, the personal information 120 regarding passwords, resources, notification, and the guest user.

The documents 138 may include (or be selected from the group consisting of) birth certificates, social security/insurance information, marriage certificate, passports, pre-marriage agreements, and other important documents 138. The emergency 140 personal information may include emergency phone numbers and non-emergency numbers. The personal information regarding insurance 144 may include form fields 122 for home insurance, automobile insurance and other related items. The personal information regarding internet 146 may include computer login information and location, e-mail accounts, and other social media account login information.

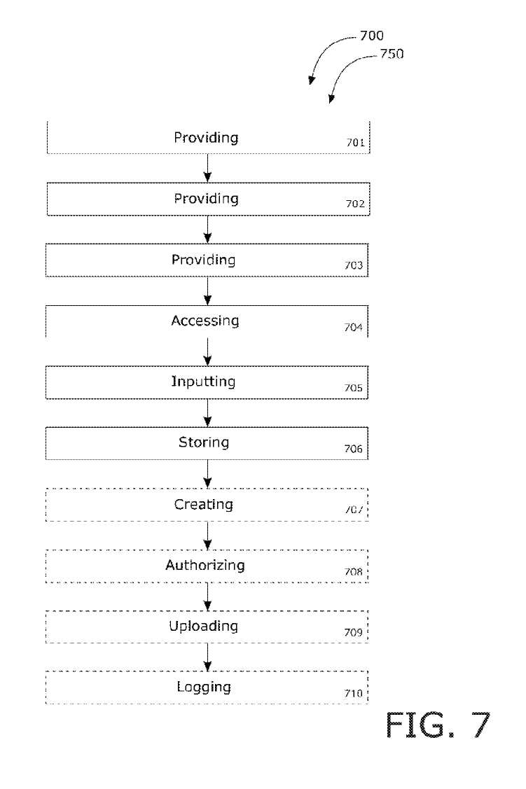

FIG. 7 is a flow diagram 750 illustrating a method of using 700 information backup system for storing personal information to be retrieved in instances of emergency 100, according to an embodiment of the present disclosure. As illustrated, the method of using 700 information backup system for storing personal information to be retrieved in instances of emergency 100 may include the steps of: step one 701, providing a software application 110 supported on a platform server including a database, the software application 110 configured for storage and access of personal information 120, step two 702, providing a computing device for installation of the software applications 110, step three 703, providing a user interface, step four 704, accessing and manipulating the software application 110 and the personal information 120, step five 705, inputting the personal information 120, step six 706, storing the personal information 120 for remote access to the personal information 120, step seven 707, creating additional categories for inputting the personal information 120, step eight 708, authorizing access for a guest-user, step nine 709, uploading the personal information 120, and step ten 710, logging in to the software application 110.

It should be noted that step seven 707, step eight 708, step nine 709, and step ten 710 are optional steps and may not be implemented in all cases. Optional steps of method of use 700 are illustrated using dotted lines in FIG. 7 so as to distinguish them from the other steps of method of use 700. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for installing, using, editing, adding information, different types of documents to be added, and storing personal information using information backup system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An information backup system comprising:
a software application supported on a platform server including a database, said software application configured for storage and access of personal information;
a computing device for installation of said software applications;
a user interface for accessing and manipulating said software application and said personal information; and
wherein said software application stores said personal information for remote access to said personal information for use.

2. The information backup system of claim 1, wherein said personal information comprises pictures, family relations, contacts, medical, employer, benefits, insurance, birth certificates, social security numbers, passports, marriage certificates, divorce certificates, debt accounts, bank accounts, website login and password information, safes, safety deposit boxes, locations of keys, asset information, wills, power of attorney, medical directives, living wills, long term care, arrangements, and organ donation.

3. The information backup system of claim 1, wherein said personal information is accessible by a user remotely.

4. The information backup system of claim 1, wherein said software application is displayed on a screen of said computing device.

5. The information backup system of claim 1, wherein said software application includes form fields to be populated and stored with said personal information.

6. The information backup system of claim 1, wherein said personal information is configured to be stored and presented through a series of selectable menus which are configured to be selected on a computing device.

7. The information backup system of claim 2, wherein said software application further comprises a user-profile.

8. The information backup system of claim 7, wherein said user comprises a guest-user in said instances of emergency.

9. The information backup system of claim 8, wherein said user authorizes said guest-user for information retrieval in instances where the user is incapacitated.

10. The information backup system of claim 7, wherein said series of selectable menus provides access to said user-profile, said personal information regarding accounts, said personal information regarding assets, said personal information regarding documents, said personal information regarding emergency, said personal information regarding employer, said personal information regarding insurance, said personal information regarding internet, said personal information regarding medical, said personal information regarding planning, said personal information regarding passwords, resources, notification, and said guest user.

11. The information backup system of claim 1, wherein said computing device comprises a computer.

12. The information backup system of claim 1, wherein said software application comprises a secure access component configured to prevent unauthorized access to said personal information.

13. The information backup system of claim 1, wherein said computing device comprises a mobile-device.

14. An information backup system comprising:
a software application supported on a platform server including a database, said software application configured for storage and access of personal information;
a computing device for installation of said software applications;
wherein said software application is displayed on a screen of said computing device;
a user interface for accessing and manipulating said software application and said personal information;
wherein said personal information comprises pictures, family relations, contacts, medical, employer, benefits, insurance, birth certificates, social security numbers, passports, marriage certificates, divorce certificates, debt accounts, bank accounts, website login and password information, safes, safety deposit boxes, locations of keys, asset information, wills, power of attorney, medical directives, living wills, long term care, arrangements, and organ donation;
wherein said personal information is accessible by a user;
wherein said user comprises a guest-user in said instances of emergency;
wherein said user authorizes said guest-user for information retrieval in instances where the user is incapacitated;
wherein said software application includes form fields to be populated and stored with said personal information;
wherein said personal information is configured to be stored and presented through a series of selectable menus which are configured to be selected on a computing device;
wherein said series of selectable menus provides access to said user-profile, said personal information regarding accounts, said personal information regarding assets, said personal information regarding documents, said personal information regarding emergency, said personal information regarding employer, said personal information regarding insurance, said personal information regarding internet, said personal information regarding medical, said personal information regarding planning, said personal information regarding passwords, resources, notification, and said guest user;
wherein said software application further comprises a user-profile;
wherein said software application comprises a secure access component configured to prevent unauthorized access to said personal information; and
wherein said software application stores said personal information for remote access to said personal information.

15. A method of using information backup system for storing personal information to be retrieved in instances of emergency, the method comprising the steps of:
providing a software application supported on a platform server including a database, said software application configured for storage and access of personal information;
providing a computing device for installation of said software applications;
providing a user interface;
accessing and manipulating said software application and said personal information;
inputting said personal information; and
storing said personal information for remote access to said personal information.

16. The method of storing personal information to be retrieved in instances of emergency of claim 15, further comprises the steps of: creating additional categories for inputting said personal information.

17. The method of storing personal information to be retrieved in instances of emergency of claim 15, further comprises the steps of: authorizing access for a guest-user.

18. The method of storing personal information to be retrieved in instances of emergency of claim 15, further comprises the steps of: uploading said personal information.

19. The method of storing personal information to be retrieved in instances of emergency of claim 15, further comprises the steps of: logging in to said software application.
